(19) United States
(12) Patent Application Publication
(10) Pub. No.: US 2004/0053112 A1
(43) Pub. Date: Mar. 18, 2004

(54) Multilayered, flexible paper containing carbon, with good flexural strength

(76) Inventors: Thomas Dolny, Esslingen (DE); Eberhard Kuebler, Renningen (DE); Karsten Loehr, Ulm (DE)

Correspondence Address: DAVIDSON, DAVIDSON & KAPPEL, LLC, 485 SEVENTH AVENUE, 14TH FLOOR, NEW YORK, NY, 10018, US

(21) Appl. No.: 10/399,561

(22) PCT Filed: Oct. 13, 2001
(86) PCT No.: PCT/EP01/11859

(30) Foreign Application Priority Data
Oct. 21, 2000 (DE) 10052223.8

(51) Int. Cl. H01M 4/96; H01M 4/94

(52) U.S. Cl. 429/44; 428/688

(57) ABSTRACT

The invention relates to electroconductive layered paper with a layer structure consisting of at least one first, one second and one third layer, comprising at least one electroconductive material in the form of carbon fibres. Said first, second and third layers are produced or deposited one after the other in an air stream, using the airlaid technique. The carbon fibres lie predominantly in the plane of the layer in the first layer (1), increasingly at a slant and/or increasingly perpendicular to the plane of the layer in the second layer (2) and are located on top of the second layer in the third layer (3) in a ground form. The invention also relates to a method for producing electroconductive layered paper and to its use as a gas diffusion electrode in polymer electrolyte membrane fuel cells.

The present invention relates to an electroconductive layered paper having a layer structure that comprises at least a first layer, a second layer, and a third layer, a method of manufacturing such an electroconductive layered paper, and its usage as a gas diffusion electrode, in particular in polymer electrolyte membrane fuel cells.

Fuel cells are systems which convert chemical energy into electrical energy. PEM fuel cells have a central membrane/electrode unit which is composed of a polymeric, proton-conducting electrolyte on which preferably smooth, water repellent, porous gas diffusion electrodes having a catalyst coating are situated on both sides. Oxygen or air is fed to the electrode on the cathode side and hydrogen is fed to the electrode on the anode side. On the anode, protons are separated from the fuel while electrons are released. The protons migrate through the proton-conductive electrolyte to the cathode, at which, under uptake of electrons, they react with oxygen to form water. Therefore, the electrodes must have good electrical conductivity, good gas permeability, sufficient mechanical rigidity, and must ensure good contact to the electrolyte via a smooth surface on the side facing the electrolyte.

In order to meet the above-mentioned requirements, modified carbon papers are used in gas diffusion electrodes, i.e., carbon papers which are compressed on the surface with carbon black or graphite. However, these materials are not sufficient with regard to surface smoothness and pore size.

The use of gas diffusion layers, which are made of a powder-like or dust-like electroconductive material in connection with particles of a thermoplastic binder, is known from German Patent Application No. DE 19 72 1952 A1. For improving the mechanical properties, these layers may additionally contain a small amount of carbonized carbon fibers or polymer fibers. For calibrating the porosity of these gas diffusion layers, chemical or physical propellants or placeholders are used, which must be partly removed again. The complex method requires accurate reaction control, in particular with regard to the formation of percolation paths.

Therefore, the object of the present invention is to provide an electroconductive layered paper which ensures reproducible porosity, and dimensional stability to prevent deformations.

In order to achieve this object, the present invention provides a layered paper having the features of claim 1, a method of manufacturing such a layered paper according to claim 16, and the usage of this layered paper as a gas diffusion electrode in a fuel cell according to claim 15.

Further advantages of the layered paper according to the present invention are, in addition to improved electrical conductivity, optimized coatability with regard to coating using polymer films, and a temperature stability adapted to the manufacturing process and the application. The desired product attributes may be generated in a targeted and, most importantly, cost-effective manner.

Moreover, the layered paper must meet the following requirement: Paper processing technology using a continuous or discontinuous method requires sufficient tensile strength in addition to high flexural strength and rollability.

The subclaims contain advantageous embodiments of the present invention.

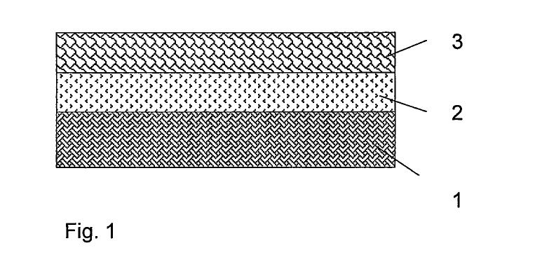

FIG. 1 schematically shows a possible structure of the layered paper according to the present invention.

The electroconductive layered paper according to the present invention is composed of a layer structure having at least a first, a second, and a third layer which differ markedly in their functionality. This is controlled by the geometry (length, etc.), morphology (smoothness, ripple, etc.), and the chemical condition of the fibers (temperature stability, chemical resistance, etc.), and finally by the manufacturing technology of the paper (airlaid technology, hot-pressing, post-treatment, etc.). Each of these layers includes at least one electroconductive material in the form of carbon fibers, the first, the second, and the third layer being successively manufactured or deposited in an air flow using airlaid technology. The carbon fibers in first layer 1 are predominantly situated in the layer plane, those in second layer 2 are situated increasingly at a slant and/or increasingly perpendicular to the layer plane, and those in third layer 3 are situated above the second layer in ground form. The first and the second layers contain long, smooth carbon or carbon-containing fibers having a length in the range of between approximately 1 mm and 12 mm, first layer 1 having a weight per unit area of at least 5 g/m² and at most 50 g/m². In contrast, the third layer has ground carbon or carbon-containing fibers having a length in the range of less than 0.5 mm. In first layer 1 and/or second layer 2 and/or third layer 3, the electroconductive layered paper contains a binder made of thermoplastic material. Based on the entire layered paper or on the respective layer, the amount of binder may range from a minimum of 0 percent in weight to 30 percent in weight, preferably from 2 to 20, particularly preferred from 5 percent in weight to 15 percent in weight. The following are considered suitable binders: polyethylene and/or polyethylene-containing polymers, polypropylene and/or polypropylene-containing polymers, polysulphone and/or polysulphone-containing polymers, polyethylene terephthalate and/or polyethylene terephthalate-containing polymers, polyamide and/or polyamide-containing polymers, fluorinated polymers, in particular polytetrafluorethylene (PTFE) and/or bi-component fibers and/or a mixture of different binders.

The geometrical structure of the core/cladding (c/c) type is preferred when bi-component fibers are used. A polyester-based bi-component fiber is used in a preferred embodiment; as an example, the trademark Trevira of the XXX type of the Hochst Company should be noted here.

However, binding fibers of the aramide type in particular, for example the trademark Kevlar of the XXX type of the DuPont Company, or Twaron of the Nippon Aramid Yugen Company (PPTA (Poly (p-phenylene terephthalamide)) are preferably used. It has been found that the use of binding fibers made of a fluorinated polymer, in particular PTFE fibers, is particularly advantageous.

The binder is mixed into or applied to, e.g., sprayed onto, in the form of powder and/or fiber, one or several layers 1, 2, and/or 3. According to the present invention, the layered paper may be made water repellent by at least one fluorinated polymer; the fluorinated polymer may be fully or partially perfluorinated and it may be a thermoplastic. In particular, polytetrafluorethylene is preferably used as a fluorinated polymer. Moreover, the layered paper may be provided with a catalytically active layer. Supported and unsupported catalysts may be used as catalysts or catalyst-containing materials. Platinum-containing and platinum-free catalysts are utilized. Catalysts that are made of or contain at least one transition metal and at least one chalcogen are preferred as platinum-free catalysts, the at least one transition metal being selected from subgroups VI b and/or VIII b of the periodic system of elements. In particular, ruthenium chalconides are preferably used. Platinum or platinum complexes having elements of the subgroup VIII b, in particular platinum-ruthenium complexes, may be used as platinum-containing catalysts, for example.

As an example, the structure of the electroconductive layered paper is explained based upon FIG. 1:

Layer (1) represents an airy arrangement of long, smooth, large fibers guaranteeing tensile strength. This layer is manufactured using airlaid technology that is known per se, in which the fibers are predominantly situated in the layer plane. Airlaid technology is known as aerodynamic matting. The fibers are finely distributed in the air via air swirling and are deposited on a support in the form of a web. An isotropic random orientation is created having greater degrees of freedom than a hydrodynamic treatment would yield. This layer is characterized by increased dimensional stability against compression during processing of the layered paper and shows increased tensile strength. Materials having good gas distribution properties are preferred as support material. This may be carbon paper, fiberglass fabric, metal wire fabric, or comparable materials.

Layer 2 also represents a mixture of long, smooth fibers and is also manufactured using airlaid technology, the fibers being situated increasingly at a slant and/or increasingly perpendicular to the layer plane via application on layer 1. Layer 2 is characterized by high gas porosity, contributing to an optimized gas distribution due to the specific arrangement of the fibers. The high flexural strength of this layer is another advantage. By varying the process parameters, the porosity may be optimally and reproducibly adjusted.

Layer 3 contains ground fibers that have a large surface and, after processing, shows an extremely smooth, microporous surface which, in the event of the layered paper being designed as a gas diffusion electrode, provides a good contact between the electrode, the catalyst, and the electrolyte.

In addition, layers 1, 2, and/or 3 may contain at least a binder and optionally a water repellent agent. The fiber-shaped and/or powder-shaped water repellent agent may contain fluorinated polymers such as polytetrafluorethylene, for example. If a binder made of a fluorinated polymer is used, the addition of a water repellent agent may be dispensed with. The fibers acting as a binder are, in the form of powder and/or fiber, applied to or mixed into the respective layer 1, 2, and/or 3 using technology that is known per se. These fibers have a thermoplastic region whose adhesive effect is utilized as a binder or a glue.

Due to layer 3, the layered paper according to the present invention has a very smooth, porous surface which is highly suitable for a further coating using polymer films, the layered paper being additionally carbonized, bonded, compressed, and smoothed using a post-treatment (oxidizing, pyrolytic treatment, and pressing). In addition, the present invention uses a layer which has a high porosity so that the reaction gases may diffuse to the catalytic layer; on the other hand, its gradient structure, formed after hot-pressing under pressure, ensures very good electrical conductivity in order to discharge the current generated in the membrane. The dimensional stability predetermined by the structure saves the use of further reinforcing structures. If the electrode does not contain a catalytically active layer, a membrane coated with a catalyst must be used. However, the layered paper according to the present invention may alternatively be provided with a catalytically active layer. The catalytic layer has to be gas-permeable and electroconductive, and be able to catalyze the electrochemical reaction. The layered paper according to the present invention as described above may be used as a gas diffusion electrode in a PEM fuel cell.

The method of manufacturing an electroconductive layered paper using airlaid technology may be executed using a system such as is described under “Hybrid Plants” in the sales brochure of M&J Fibretech A/S, 8700 Horsens/Denmark. The technology itself is known in principle from the field of nonwovens, i.e., from the field of fiber composites and textile composites, in particular nonwoven fabrics. The website http://www.nonwovens.com/facts/technology/overview.htm may be used as a reference source.

A system having three or more laying heads which are situated in a tandem formation one behind the other is used for manufacturing an electroconductive layered paper. The first, second, and third layer of the layered paper is produced by depositing the carbon fibers in an air flow using airlaid technology, the length of the fibers in the first and second layers being selected to be greater than of those in the third layer. The first layer is formed by depositing carbon fibers having a length of 1 mm to 12 mm, and a fiber cross section of approximately 5 μm² to 15 μm² in an air flow of 1 m/s to 7 m/s and a deposit speed of 0.02 m/s to 5 m/s with a weight per unit area of 5 g/m² to 50 g/m² on a smooth base, i.e., a substrate, the fibers being deposited predominantly in the layer plane. The second layer is subsequently produced using a second layer head under approximately the same operating conditions as the first layer. Surprisingly, it has been found that the fibers are increasingly oriented at a slant and/or perpendicularly to the layer plane, a continuous, gradual transition between the two adjacent layers being formed via a local fiber orientation, the transition providing a first gradient with respect to the morphological properties of the layered paper. Under approximately the same operating conditions which were used in manufacturing the first two layers, a subsequent third layer head deposits ground fibers smaller than 0.5 mm on the second layer. In this process step, these ground fibers sink partly into the subjacent layers and in turn represent in this way a gradual, continuous transition with respect to the morphological properties of the layered paper.

The layers lying on top of each other, with a binder introduced into at least one of the layers, are heat-pressed at high pressure and temperature, the ground fibers further penetrating into the other layers, decreasingly from top to bottom. These layers lose their discrete design due to the manufacturing method and blend with one another at their adjacent areas so that in addition to the gradient, built up by the carbon fibers and ground fibers, a smooth and continuous transition of the layers within the overall structure results. The interspaces of the structure are filled with ground fibers. The increased packing density results in greater electrical conductivity and greater dimensional stability, e.g., against compression, such as is occurring during assembly of a membrane electrolyte unit. Furthermore, after the pressing step, the ground fibers form a layer of high density and a fine pore structure having a very smooth surface which is very advantageously suitable for coating using polymer films. The previously mentioned binders simultaneously develop their adhesive effect at temperatures between 80° C. and 500° C., preferably between 120° C. and 420° C., bonding the different fibers together. An internal net is formed, hereby counteracting delaminating or warping of the individual layers in a controlled manner.

In a further work step, the layers, placed on top of each other, or the already heat-pressed layered paper are, simultaneously or as an aftertreatment, subjected to oxidizing, pyrolytic treatment, and pressing using known technology for the manufacture of carbon papers, the paper being additionally carbonized, bonded, compressed, and smoothed. The thickness of the layered paper is in the range of 30 μm to 150 μm, preferably in the range of 50 μm to 120 μm. Due to its flexibility and its flexural strength, the layered paper according to the present invention may be advantageously used in rolls in paper-processing technology.

If the electrode does not contain a catalytically active layer, a membrane coated with a catalyst must be used. However, the layered paper according to the present invention may be alternatively provided with a catalytically active layer. This layer may be applied, e.g., via screen printing, spraying, or electrochemical deposition according to the related art. The claimed layered paper may be combined to form a membrane electrode unit using a polymer electrolyte membrane, in such a way that the smooth side of the layered paper, which may contain the catalytically active layer, is pressed together with the electrolyte membrane at a specified temperature and a specified pressure. The layered paper obtained that way is used as a gas diffusion electrode in fuel cells.

What is claimed is:

1. An electroconductive layered paper having a layered structure, comprising at least a first, a second, and a third layer, including at least one electroconductive material in the form of carbon fibers,
wherein the first, the second, and the third layer are successively manufactured or deposited in an air flow using airlaid technology, the carbon fibers being situated predominantly in the layer plane in the first layer 1, increasingly at a slant and/or increasingly perpendicular to the layer plane in the second layer 2, and in ground form above the second layer in the third layer 3.

2. The electroconductive layered paper as recited in claim 1,
wherein the first layer 1 and the second layer 2 contain carbon and/or carbon-containing fibers having a length in the range of between approximately 1 mm and 12 mm.

3. The electroconductive layered paper as recited in claim 1,
wherein the third layer 3 contains ground carbon and/or carbon-containing fibers having a length in the range of less than 0.5 mm.

4. The electroconductive layered paper as recited in claim 1,
wherein the first layer 1 has a weight per unit area of at least 5 g/m² and at most 50 g/m².

5. The electroconductive layered paper as recited in claim 1,
wherein the first layer 1 and/or the second layer 2 and/or the third layer 3 contain a binder.

6. The electroconductive layered paper as recited in claim 5,
wherein the binder is a thermoplastic material.

7. The electroconductive layered paper as recited in claim 6,
wherein the thermoplastic material contains polyethylene, polypropylene, polysulphone, polyethylene terephthalate, polyamide, fluorinated thermoplastics, and/or bi-component fibers.

8. The electroconductive layered paper as recited in claim 7,
wherein the geometrical arrangement of the bi-component fibers is preferably of the core/cladding (c/c) type.

9. The electroconductive layered paper as recited in claim 8,
wherein the bi-component fiber is preferably on a polyester basis.

10. The electroconductive layered paper as recited in claim 5,
wherein the binder in the form of powder and/or fiber is mixed into or applied to one or several layers 1, 2, and/or 3.

11. The electroconductive layered paper as recited in claim 1,
wherein the layered paper is made water repellent using a fluorinated polymer.

12. The electroconductive layered paper as recited in claim 1,
wherein the layered paper is provided with a catalytically active layer.

13. The electroconductive layered paper as recited in claim 1,
wherein a gradient-type structure is formed in the layered paper after heat-pressing under pressure.

14. The electroconductive layered paper as recited in claim 1,
wherein the layered paper is additionally carbonized, bonded, compressed, and smoothed by a post-treatment (oxidizing, pyrolytic treatment, and pressing).

15. The use of the electroconductive layered paper as recited in at least one of claims 1 through 14 as a gas diffusion electrode for a polymer electrolyte membrane fuel cell.

16. The method of manufacturing an electroconductive layered paper as recited in one of claims 1 through 14, in which the first, the second, and the third layer are manufactured by depositing carbon fibers in an air flow using airlaid technology, the length of the fibers being selected such that it is greater in the first and second layer than in the third layer.

17. The method of manufacturing an electroconductive layered paper as recited in claim 16, in which the first layer is manufactured by depositing carbon fibers of a length of 1 mm to 12 mm and a weight per unit area of 5 g/m² to 50 g/m² in an air flow of 1 m/s to 7 m/s and a deposition speed of 0.02 m/s to 5 m/s on a smooth base.

18. The method of manufacturing an electroconductive layered paper as recited in claim 17, in which the second layer is manufactured under approximately the same operating conditions as the first layer.

19. The method of manufacturing an electroconductive layered paper as recited in claim 18, wherein, in manufacturing the third layer, the fiber length is less than 0.5 mm and the third layer is manufactured under approximately the same operating conditions as the first two layers.

20. The method of manufacturing an electroconductive layered paper as recited in claim 19, wherein, after the manufacture of the three layers, the layer structure is compressed at high pressure and temperature with a binder which is introduced into at least one layer.

21. The method of manufacturing an electroconductive layered paper as recited in claim 20, wherein, after heat-pressing under pressure, a gradient-type structure is created in the layer structure.
